(19) United States
(12) Patent Application Publication
(10) Pub. No.: US 2015/0068410 A1
(43) Pub. Date: Mar. 12, 2015

(54) Grill Food Catcher

(71) Applicant: Garry Dean Boevers, Edmond, OK (US)

(72) Inventor: Garry Dean Boevers, Edmond, OK (US)

(21) Appl. No.: 14/025,187

(22) Filed: Sep. 12, 2013

(51) Int. Cl. A47J 37/07

(52) U.S. Cl. CPC A47J 37/0786
USPC 99/426; 29/428

(57) ABSTRACT

One embodiment of a wire mesh/sheet metal (10) attached to the bottom of a grill (12) using connectors (14). The wire mesh/sheet metal (10) is made of a material that can withstand high heat and is non-toxic or can be protected to withstand high heat and be non toxic.

### PRIOR ART

The following is some prior art that presently appears relevant

### U.S. Patent Application Publications

| Publication Nr. | Kind Code | Publ. Date | Applicant |
|---|---|---|---|
| U.S. Pat. No. 4,510,855 | A | 1985-04-16 | Corey B. Avner |
| WO1996036265 | A1 | 1996-11-21 | Marvin Fabrikant, |
| | | | Patricia Fabrikant |

### BACKGROUND

Various attempts have been made to develop devices for cooking or grilling food with the idea of not losing the food between the openings of the grill. For example, U.S. Pat. No. 4,510,855 describes a secondary grilling apparatus and WO1996036265 describes a Device for cooking or grilling small pieces of food and method of use. The problem observed with these and other similar inventions is they were placed on the surface or just above the grill. For the devices that are easily removable it is just another apparatus to keep track of. For devices that are more permanently attached it is just another apparatus consuming grill space. In both cases it removes the food from being cooked directly on the grill itself, which is one of the primary reasons one grills, to get the grill marks on the food you are cooking. By not cooking directly on the grill you are not taking advantage of what is usually the most expensive part of your cooking device the grill itself.

### SUMMARY

In accordance with one embodiment a wire mesh or sheet metal attached directly to the bottom of a grill will prevent food from falling through a grill.

### ADVANTAGES

Accordingly several advantages of one or more aspects are as follows: to provide a permanent fix to keep food from falling through a grill, that leaves the grill surface unobstructed, that allows grilling on the grill itself, that is relatively inexpensive, that will be very low maintenance compared to baskets or pans that sit on the grill, which can fit any size grill, and will make the entire grill safe from losing food. Other advantages of one or more aspects will be apparent from a consideration of the drawings and ensuing description.

### DRAWINGS—FIGURES

FIG. 1 shows a top down view of a grill with the wire mesh sheet metal attached to the bottom of the grill.

FIG. 2 shows a bottom up view of the wire mesh/sheet metal attached to the bottom of a grill.

FIG. 3 shows a perspective view of a grill and the wire mesh/sheet metal and how it is to be attached to the bottom of the grill.

FIG. 4 shows a perspective view of a grill and the wire mesh/sheet metal and how it is to be attached to the bottom of the grill

### DRAWINGS—REFERENCE NUMERALS

10 Wire Mesh/Sheet Metal
12 Grill
14 Connectors

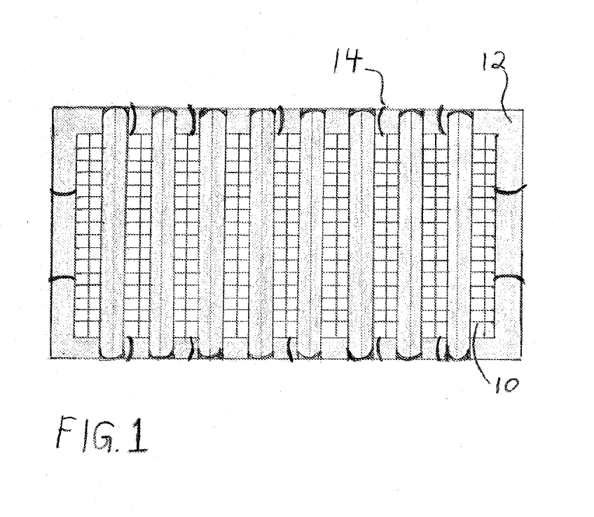

### DETAILED DESCRIPTION—FIGS. 1, 2, 3, 4

### First Embodiment

One embodiment of the grill food catcher is illustrated in FIG. 1 (top view). The wire mesh/sheet metal 10 covers all of the open slots from the bottom between the grill 12. The wire mesh/sheet metal is typically made out of galvanized or stainless steel. However, the wire mesh/sheet metal can be made of any material that can withstand high heat and is non toxic or can be protected to withstand high heat and be non toxic. The wire mesh/sheet metal 10 is attached to the bottom of the grill with connectors 14. The connectors 14 can be made out of any material that can withstand high heat and is non toxic or can be protected to withstand high heat and be non toxic. The connectors 14 can be in the shape of wire or flat like a zip tie or any other shape that can securely attach the wire mesh/sheet metal 10 to the grill 12.

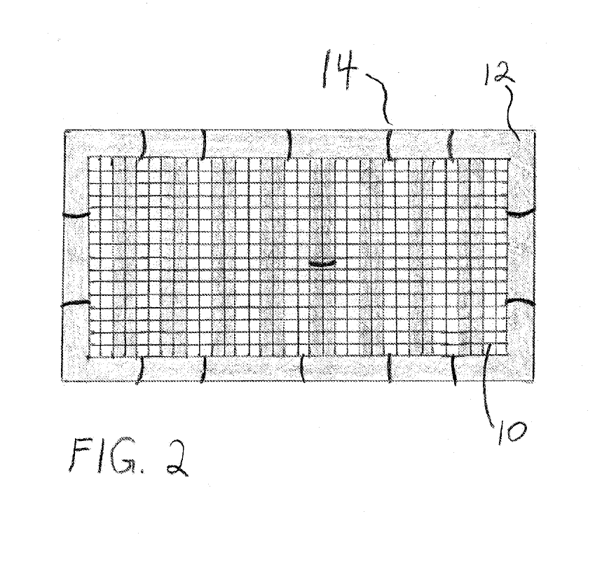

One embodiment of the grill food catcher is illustrated in FIG. 2 (bottom view). The wire mesh/sheet metal 10 covers the grill 12 bottom to within about a half inch or less of the outside portion of the grill 12. This is to allow the grill to rest on its support without the wire mesh/sheet metal 10 interfering. In this view we show a connector 14 towards the middle of the grill 12. Additional connectors 14 can be added if they are needed to keep the wire mesh/sheet metal 10 tightly attached to the bottom of the grill 12.

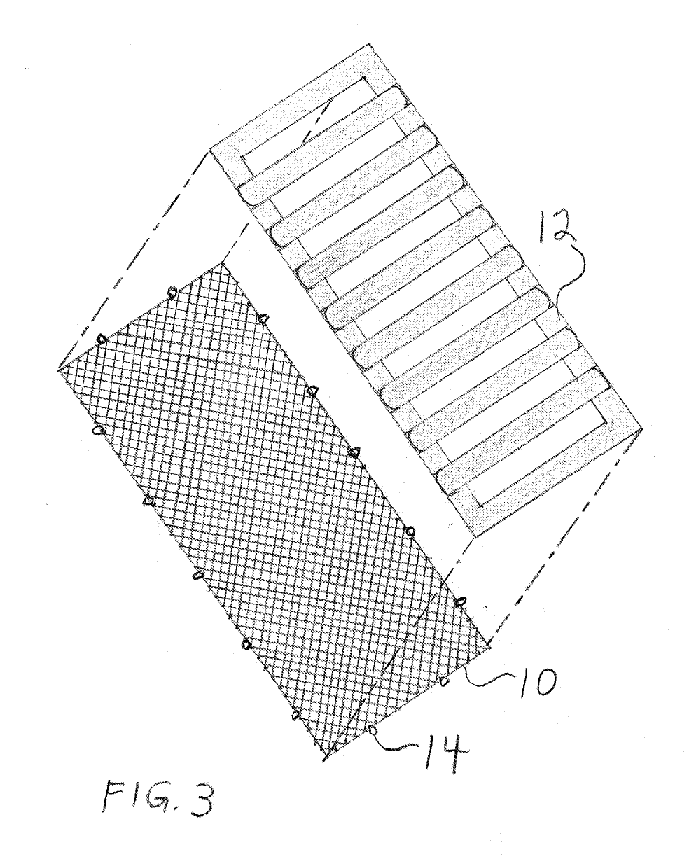

One embodiment of the grill food catcher is illustrated in FIG. 3 (perspective view). The wire mesh/sheet metal 10 is shown with diamond shaped openings and an independent item prior to being attached using the connectors 14 to the bottom of the grill 12. This is to illustrate that the design of the wire mesh/sheet metal 10 can take any shape as long as it allows proper heat flow up and juice flow down.

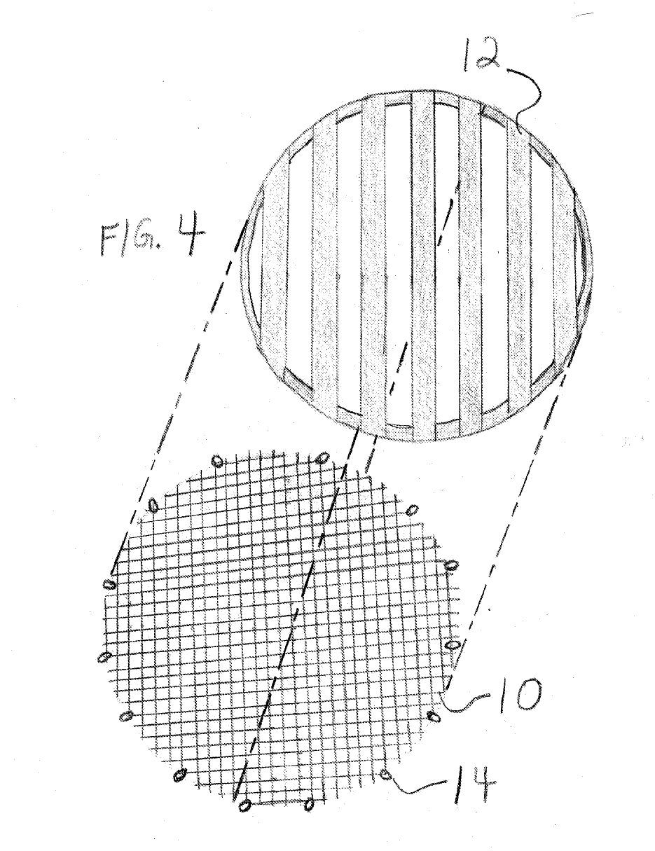

One embodiment of the grill food catcher is illustrated in FIG. 4 (perspective view). The wire mesh/sheet metal 10 is shown in a circular shape and as an independent item prior to being attached using the connectors 14 to the bottom of the grill 12. This is to illustrate that the grill can take on any shape or size and the wire mesh/sheet metal 10 can be made to fit it.

### ADVANTAGES

From the description above, a number of advantages of some embodiments of my grill food catcher become evident:
(a) After the installation of the grill food catcher you won't have to worry about food falling through the grill any longer.
(b) Once installed the grill food catcher can be left in place and doesn't have to be removed, washed, or stored in a separate place like cooking pans or baskets.
(c) The grill food catcher leaves your grill surface unobstructed for optimum grilling
(d) The grill food catcher can be made to fit any shape or size grill.
(e) The grill food catcher will be relatively inexpensive to make.
(f) The grill food catcher can be made out of wire mesh with different size openings or sheet metal with different size openings.

### CONCLUSIONS, RAMIFICATION, AND SCOPE

Accordingly, the reader will see that by attaching the wire mesh/sheet metal to the bottom of a grill that the openings in the grill can be covered to prevent food from falling into the heat source. The wire mesh/sheet metal with appropriate size openings will allow the heat to cook the food with no interference. It will also allow juices from the food to fall on the heat source as designed to enhance the flavor of grill cooking. Once attached you should never have to worry about losing food through the grill again. The grill food catcher can be made to fit any shape or size grill. The grill food catcher once attached to the bottom of the grill can be permanently left attached requiring less maintenance than baskets and pans and no additional storage space or more accessories to keep track of. The grill food catcher allows grilling directly on the grill itself. The grill food catcher does not interfere with the use of the grill, but provides the cook with the confidence of never losing food between the grill again.

Although the description above contains many specificities, these should not be construed as limiting the scope of the embodiments but as merely providing illustrations of some of several embodiments. For example, the grill food catcher can be made of various size mesh wire with different size and shaped openings. It can also be made of sheet metal with different size and shaped openings. The mesh wire/sheet metal and connectors need to be made of material that can withstand high heat and is non toxic or protected to withstand high heat and be non toxic.

Thus the scope of the embodiments should be determined by the appended claims and their legal equivalents, rather than the examples given.

I claim:

1. A method for keeping food from falling between a grill, comprising:
a. A wire mesh attached to the bottom of a grill using connectors.
b. A sheet metal attached to the bottom of a grill using connectors.

2. The wire mesh of claim 1 wherein said mesh can be of various shape and size openings.

3. The sheet metal of claim 1 wherein said sheet metal can be of various shape and size openings.

4. The wire mesh of claim 1 wherein said mesh can be made to fit any shape or size grill.

5. The sheet metal of claim 1 wherein said sheet metal can be made to fit any shape or size grill.

6. The wire mesh of claim 1 wherein said mesh can be made of any material that can withstand high heat and is non toxic or can be protected to withstand high heat and be non toxic.

7. The sheet metal of claim 1 wherein said sheet metal can be made of any material that can withstand high heat and is non toxic or can be protected to withstand high heat and be non toxic.

8. The connectors of claim 1 wherein said connectors can be made of any material that can withstand high heat and is non toxic or can be protected to withstand high heat and be non toxic.
